(19) United States
(12) Patent Application Publication
(10) Pub. No.: US 2011/0065858 A1
(43) Pub. Date: Mar. 17, 2011

(54) Adhesive composition and adhesive film

(75) Inventors: Takahiro Asai, Kawasaki-Shi (JP); Koichi Misumi, Kawasaki-Shi (JP); Toshiyuki Ogata, Kawasaki-Shi (JP); Motoki Takahashi, Kawasaki-Shi (JP); Hirofumi Imai, Kawasaki-Shi (JP)

(73) Assignee: Tokyo Ohka Kogyo Co., Ltd., Kawasaki-Shi (JP)

(21) Appl. No.: 12/924,583

(22) Filed: Sep. 29, 2010

Related U.S. Application Data
(63) Continuation of application No. 12/322,145, filed on Jan. 29, 2009, now abandoned.

(30) Foreign Application Priority Data
Jan. 30, 2008 (JP) 019179/2008
Apr. 16, 2008 (JP) 106666/2008

(51) Int. Cl. C09J 133/24

(52) U.S. Cl. 524/548

(57) ABSTRACT

An adhesive composition of the present invention includes a polymer as a main component. The polymer is produced by copolymerization of a monomer composition which includes chain-structured alkyl (meth)acrylate and a monomer containing a maleimide group. This makes it possible to provide an adhesive composition used for forming an adhesive layer in which adhesive strength is kept in a high temperature environment. That is, it becomes possible to provide an adhesive composition that allows forming an adhesive layer which has high adhesive strength in a high temperature environment (particularly at 200° C. to 250° C.).

This Nonprovisional application claims priority under 35 U.S.C. §119(a) on Patent Application No. 019179/2008 filed in Japan on Jan. 30, 2008, and No. 106666/2008 filed in Japan on Apr. 16, 2008, the entire contents of which are hereby incorporated by reference.

### FIELD OF THE INVENTION

The present invention relates to an adhesive composition and an adhesive film. More specifically, the present invention relates to an adhesive composition and an adhesive film that are used, in a process such as a grinding process of, for example, a semiconductor product (such as a semiconductor wafer) and an optical product, for attaching a sheet or a protective substrate to the semiconductor product temporarily.

### BACKGROUND OF THE INVENTION

In these years, sophistication of mobile phones, digital audiovisual apparatuses, and IC cards has lead to increased demands for reduction in size, reduction in thickness, and higher integration of a semiconductor silicon chip (hereinafter, referred to as a chip) to be mounted. Moreover, regarding an integrated circuit including a CSP (chip size package) and an MCP (multi-chip package) each of which has a plurality of chips in one package, reduction in thickness of such chips is also demanded. In this trend, a System-in-Package (SiP) that has a plurality of semiconductor chips in one package is a very important technology (i) for realizing the reduction in size, the reduction in thickness, and higher-integration of the chips to be mounted, and (ii) also for sophistication of electric devices and reduction in size and weight of the electric devices.

In order to meet a demand for slimmer products, a thickness of a chip needs to be reduced to 150 μm or less. Moreover, a thickness of a chip needs to be reduced to 100 μm or less for a CSP and a MCP, and 50 μm or less for an IC card.

Conventionally, in SiP products, bumps (electrodes) of each of multilayer chips and a circuit board are wired according to a wire bonding technology. A technology necessary to meet the demands for reduction in thickness and higher integration is not the wire bonding technology but a through electrode technology. In the through electrode technology, layers of a chip including through electrodes are formed and bumps are provided on a rear surface of the chip.

In production of a thin chip, for instance, first, a wafer is produced by slicing, for example, a high-purity silicon single crystal. Then, an integrated circuit is formed by etching a predetermined circuit pattern such as, integrated circuit on a front surface of the wafer, and a rear surface of the obtained semiconductor wafer is grinded by a grinding machine. After the semiconductor wafer is grinded to a predetermined thickness, the semiconductor wafer is made into chips by dicing. In this case, the predetermined thickness is approximately 100 μm to 600 μm. Further, in a case where through electrodes is provided in a chip, the wafer is grinded to the thickness of approximately 50 μm to 100 μm.

A semiconductor wafer itself is thin and fragile, and has an unlevel surface because of circuit patterns provided on the semiconductor wafer. Therefore, in production of semiconductor chips, the semiconductor wafer is easily damaged if an external force is applied during transfer of the semiconductor wafer to a grinding process or a dicing process. Moreover, in the grinding process, the semiconductor wafer is grinded while a rear surface of the semiconductor wafer is cleaned with the use of purified water so that (i) grinding dust produced is removed and (ii) heat generated in the grinding is removed. In this process, it is necessary to prevent the circuit pattern surface from being contaminated by the purified water used for cleaning.

In order to protect the circuit pattern surface of the semiconductor wafer and to prevent damage to the semiconductor wafer, a processing adhesive film is attached on the circuit pattern surface. Then, the grinding process is carried out.

At the time of dicing, a protective sheet is attached on the rear surface of the semiconductor wafer, and then the semiconductor wafer is diced while being fixed adhesively. Thus obtained chip is pushed up from a base film side by a needle and picked up. The picked up chip is fixed on a die pad.

A known example of a processing adhesive film or a protective sheet is a film in which an adhesive layer made of an adhesive composition is provided on a base film. The base film may be made of, for example, polyethylene terephthalate (PET), polyethylene (PE), polypropylene (PP), or ethylene-vinyl acetate copolymer (EVA) (e.g., Japanese Unexamined Patent Publication No. 173993/2003 (Tokukai 2003-173993) (published on Jun. 20, 2003), Japanese Unexamined Patent Publication No. 279208/2001 (Tokukai 2001-279208) (published on Oct. 10, 2001), and Japanese Unexamined Patent Publication No. 292931/2003 (Tokukai 2003-292931) (published on Oct. 15, 2003).

It is also disclosed to use, instead of a processing adhesive film or a protective sheet, a protective substrate in which aluminum nitride-boron nitride porous sintered body impregnated with ladder silicone oligomer and to stick the protective substrate and a semiconductor wafer by use of a thermoplastic film. (Japanese Unexamined Patent Publication No. 203821/2002 (Tokukai 2002-203821) (published on Jul. 19, 2002).

Alternatively, the following process is carried out, accompanying multi-layer wiring of a semiconductor element. In the process, a protective substrate is attached, by use of an adhesive composition, to a front surface of a semiconductor wafer on which a circuit is formed. Then, a rear surface of the semiconductor wafer is grinded. Subsequently, the grinded surface is etched and a mirror surface is produced. Then, a rear surface circuit is formed on the mirror surface. In this case, until the rear surface circuit is formed, the protective substrate is kept attached. (Japanese Unexamined Patent Publication No. 158145/1986 (Tokukaisho 61-158145) (published on Jul. 17, 1986))

### SUMMARY OF THE INVENTION

However, for example, conventional adhesive films have following problems in the use in the step, such as formation of through electrodes, that requires a process at a high temperature and a process in a high vacuum atmosphere. The problems include shortage in adhesive strength in a high temperature environment, adhesion failure due to gas generation in a high vacuum atmosphere, and peeling failure in which, for example, residue is left in peeling off the film after the process at the high temperature.

For instance, in formation of through electrodes, after bumps are formed on semiconductor chips, it is required to heat up the chips to approximately 200° C. and further to produce a high vacuum atmosphere when semiconductor chips are connected with each other. However, an adhesive composition constituting an adhesive layer of a protective tape in Japanese Unexamined Patent Publications No. 173993/2003 and No 279208/2001 are not resistant to such a high temperature as 200° C. Moreover, adhesion failure occurs because a gas is generated in the adhesive layer by the heating.

Moreover, a thin semiconductor wafer needs to be peeled from a protective substrate after grinding and dicing. However, an adhesive composition constituting the adhesive layer of the protective tape in Japanese Unexamined Patent Publication No. 292931/2003 is made of an epoxy resin composition. At such a high temperature as 200° C., properties of the epoxy resin composition alter and the epoxy resin composition hardens. This causes peeling failure in which residue is left in peeling off the film.

Moreover, a thermoplastic film is used for attaching a protective substrate to a semiconductor wafer in Japanese Unexamined Patent Publication No. 203821/2002. This thermoplastic film has a problem in that adhesion failure occurs because of gas generation due to absorbed moisture. In a method for processing a semiconductor substrate described in Japanese Unexamined Patent Publication No. 158145/1986, a process for producing a mirror surface with the use of an etching solution and a metal-film formation by vacuum deposition are performed. Therefore, an adhesive composition for attaching a protective substrate to a semiconductor wafer is required to have heat resistance and peelability (detachability). However, Japanese Unexamined Patent Publication No. 158145/1986 does not disclose composition of the adhesive composition.

According to a research by inventors of the present invention, an adhesive using an acrylic resin material is suitable for processing of a semiconductor wafer and a chip because the acrylic resin material has excellent crack resistance. However, problems described below are found even in an adhesive made of an acrylic resin material.

When an adhesive layer and a protective substrate are subjected to thermocompression, gas is generated from moisture absorbed by the adhesive layer. The gas causes a peeled part in a foam shape in an adhesive boundary. This reduces adhesive strength in a high temperature environment. Moreover, such gas generation not only reduces adhesive strength in a high temperature environment but also causes a trouble in producing or keeping a vacuum environment in a case where processing under a vacuum environment is to be carried out.

In the case of a step where a semiconductor wafer is exposed to an alkaline solution such as alkaline slurry or alkaline developer, a contact face of adhesive composition with respect to the semiconductor wafer deteriorates due to, for example, peeling, meltdown, and/or dispersion caused by the alkaline solution.

In a case where the adhesive is heated to approximately 200° C., properties of the adhesive composition alter because of low heat resistance. This causes peeling of an adhesive before a peeling step, and/or peeling failure due to formation of an insoluble material in a peeling solution.

The present invention is attained in view of the above problems. An object of the invention is to provide an adhesive composition (i) which has high adhesive strength, high heat resistance, and high alkali resistance in a high temperature environment (particularly at 200° C. to 250° C.) and (ii) which makes it possible to produce an adhesive easily peeled from, for example, a semiconductor wafer or a chip even after processes in a high temperature and/or a high vacuum environment (hereinafter, simply referred to as a “high temperature process”).

In order to solve the problem above, an adhesive composition of the present invention includes: a polymer as a main component, the polymer being produced by copolymerization of a monomer composition containing chain-structured alkyl (meth)acrylate, the monomer composition further containing a monomer containing a maleimide group.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a graph showing a result of measuring adhesive strength of an adhesive composition according to an embodiment of the present invention in different temperature environments.

### DESCRIPTION OF THE EMBODIMENTS

### Adhesive Composition

An embodiment of an adhesive composition of the present invention is explained below.

The adhesive composition of the present invention includes: a polymer as a main component, the polymer being produced by copolymerization of a monomer composition containing chain-structured alkyl (meth)acrylate, the monomer composition further containing a monomer containing a maleimide group (hereinafter, referred to as a maleimide-group-containing monomer).

Usage of the adhesive composition of the present invention is not specifically limited as long as the adhesive is used as an adhesive. The present embodiment explains, as an example, a case where an adhesive composition of the present invention is used for attaching a semiconductor wafer to a support plate temporarily for a wafer support system.

As used herein, the term “main component” indicates that the component is contained more than any other component in the adhesive composition of the present invention. Therefore, as long as a content of the main component is the largest among that of any other component in the adhesive composition, the content of the main component is not limited. On condition that a total amount of the adhesive composition is 100 parts by mass, it is preferable that the content of the main component is not less than 50 parts by mass but not more than 100 parts by mass. It is more preferable that the content of the main component is not less than 70 parts by mass but not more than 100 parts by mass. An adhesive composition in which the content of the main component is not less than 50 parts by mass sufficiently provides effects obtained by the adhesive composition of the present invention, that is, high heat resistance, high adhesive strength in a high temperature environment (particularly at 200° C. to 250° C.), alkali resistance, and easiness in peeling after a high temperature process such as a heating process which includes heating at 250° C. for one hour.

As used herein, the term “support plate” indicates a substrate for protecting a semiconductor wafer. This substrate is attached to the semiconductor wafer at the time when the semiconductor is grinded, so that the semiconductor wafer thinned down by the grinding is prevented from cracking or warping.

(Maleimide-Group-Containing Monomer)

In the adhesive composition of the present invention, the monomer composition further contains maleimide-group-containing monomer. The adhesive composition including a maleimide-group-containing monomer has an imide ring (imide-group-containing heterocycle) in a main chain of a main component polymer. This improves heat resistance and adhesive strength in a high temperature environment (particularly at 200° C. to 250° C.). Further, the adhesive composition can be peeled off easily after a high temperature process such as a heating process which includes heating at 250° C. for one hour.

A maleimide-group-containing monomer is not limited, as long as the monomer includes a maleimide group and can be copolymerized with another monomeric component. However, it is preferable that the maleimide-group-containing monomer is a compound represented by the following formula (I):

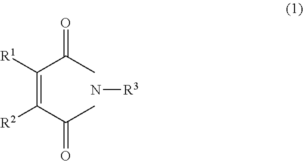

(Each of R¹ to R³ independently represents a hydrogen atom or an organic group having 1 to 20 carbon atom(s). The organic group may contain an oxygen atom, a nitrogen atom, a sulfur atom, and a halogen atom).

In the formula (1), an organic group represented as R¹ or R² is, preferably, a hydrogen atom, a methyl group, or an ethyl group. It is particularly preferable that the organic group is a hydrogen atom.

In the formula (1), an organic group represented as R³ is, preferably, an organic group including an alkyl group in a straight chain or a branched chain, an aliphatic cyclic hydrocarbon group, an aryl group, an aralkyl group, or a maleimide group. It is particularly preferable that the organic group represented as R³ is an organic group including the alkyl group, the aliphatic cyclic hydrocarbon group, or the aryl group.

As used herein, the term “aliphatic” is defined as a term representing a concept relative to “aromatic” and indicating a group or a compound which does not have aromaticity. For instance, the term “aliphatic cyclic hydrocarbon group” represents a monocyclic hydrocarbon group or polycyclic hydrocarbon group that does not have aromaticity.

The alkyl group, the aliphatic cyclic hydrocarbon group, and the aryl group represented as R³ may contain a substituent. The substituent is not specifically limited. Examples of the substituent are a halogen atom, a straight-chain or branched-chain alkyl group having 1 to 6 carbon atom(s), and an aliphatic cyclic hydrocarbon group having 3 to 6 carbon atoms. As used herein, the term “to contain a substituent” indicates that a part of or all of hydrogen atoms in the alkyl group, the aliphatic cyclic hydrocarbon group, or the aryl group is substituted with the substituent. The halogen atom includes a fluorine atom, a chlorine atom, a bromine atom, and an iodine atom. Especially, the fluorine atom is preferable as the halogen atom.

Specific examples of the alkyl group represented as R³ are a methyl group, an ethyl group, a propyl group, a butyl group, a pentyl group, a hexyl group, a heptyl group, an octyl group, a lauryl group, a stearyl group and the like. Especially, the methyl group is preferable as the alkyl group.

Specific examples of the maleimide-group-containing monomer whose organic group represented as R³ is an alkyl group are N-methylmaleimide, N-ethylmaleimide, N-n-propylmaleimide, N-isopropylmaleimide, N-n-butylmaleimide, N-isobutylmaleimide, N-sec-butylmaleimide, N-tert-butylmaleimide, N-n-pentylmaleimide, N-n-hexylmaleimide, N-n-heptylmaleimide, N-n-octylmaleimide, N-laurylmaleimide, N-stearylmaleimide and the like. N-methylmaleimide is particularly preferable in view of heat resistance and stability in industrial supply.

Specific examples of the aliphatic cyclic hydrocarbon group represented as R³ are a cyclopropyl group, a cyclobutyl group, a cyclopentyl group, a cyclohexyl group, a cycloheptyl group, a cyclooctyl group and the like. Cyclohexyl group is particularly preferable as the aliphatic cyclic hydrocarbon group.

Examples of the maleimide-group-containing monomer whose organic group is represented as R³ is the aliphatic cyclic hydrocarbon group are N-cyclopropylmaleimide, N-cyclobutylmaleimide, N-cyclopentylmaleimide, N-cyclohexylmaleimide, N-cycloheptylmaleimide, N-cyclooctylmaleimide and the like. N-cyclohexylmaleimide is particularly preferable in view of heat resistance and stability in industrial supply.

Examples of the aryl group represented as R³ are a phenyl group, a methylphenyl group and the like. Phenyl group is particularly preferable as the aryl group.

Examples of the maleimide-group-containing monomer whose organic group represented as R³ includes an aryl group are N-phenylmaleimide, N-m-methylphenylmaleimide, N-o-methylphenylmaleimide, N-p-methylphenylmaleimide and the like. N-phenylmaleimide is particularly preferable in view of heat resistance and stability in industrial supply.

Examples, other than the cited above, of the maleimide-group-containing monomer include N-benzylmaleimide, N-phenethylmaleimide, 1-methyl-2,4-bismaleimidebenzene, N,N′-m-phenylenebismaleimide, N,N′-p-phenylenebismaleimide, N,N′-m-toluilenebismaleimide, N,N′-4,4-biphenylenebismaleimide, N,N′-4,4-(3,3′-dimethyl-biphenylene)bismaleimide, N,N′-4,4-(3,3′-dimethyldiphenylmethane)bismaleimide, N,N′-4,4-(3,3′-diethyldiphenylmethane)bismaleimide, N,N′-4,4-diphenylmethanebismaleimide, N,N′-4,4-diphenylpropanebismaleimide, N,N′-3,3′-diphenylsulfonebismaleimide, N,N′-4,4-diphenyletherbismaleimide and the like.

The maleimide-group-containing monomers, which are included in the main component polymer of the adhesive composition of the present invention may be used solely, or in combination of two or more.

A mixed amount of the maleimide-group-containing monomer is not limited as long as a copolymerization reaction with another compound contained in a monomer composition proceeds. The mixed amount may be determined as appropriate depending on intended characteristics of the adhesive composition, such as adhesive strength and heat resistance. However, on condition that a total amount of the monomer composition including alkyl (meth)acrylate and a maleimide-group-containing monomer is 100 parts by mass, the mixed amount of the maleimide-group-containing monomer is preferably not less than 1 part by mass but not more than 50 parts by mass. More preferably, the mixed amount is not less than 5 parts by mass but not more than 30 parts by mass. In a case where the mixed amount is not less than 1 part by mass, an obtained adhesive layer can be further improved in heat resistance and adhesive strength in a high temperature environment. In a case where the mixed amount is not more than 50 parts by mass, the adhesive layer can be peeled off more easily after a high temperature process.

Moreover, a content of a repeat unit of maleimide-group-containing monomer included in a polymer produced by copolymerization of a monomer composition is preferably not less than 1 mol % but not more than 20 mol %. More preferably, the content is not less than 5 mol % but not more than 15 mol %. In a case where the content is not less than 1 mol %, an obtained adhesive layer can be further improved in heat resistance and adhesive strength in a high temperature environment. In a case where the content is not more than 20 mol %, the adhesive layer can be more easily peeled off after a high temperature process.

(Chain-Structured Alkyl (Meth)acrylate)

An adhesive composition of the present invention includes chain-structured alkyl (meth)acrylate in a monomer composition.

As used herein, the term “alkyl (meth)acrylate” indicates acrylic long-chain alkyl ester containing an alkyl group having 15 to 20 carbon atoms and acrylic alkyl ester containing an alkyl group having 1 to 14 carbon atom(s).

An example of the acrylic long-chain alkyl ester is alkyl acrylate or alkyl methacrylate whose alkyl group is, for example, an n-pentadecyl group, an n-hexadecyl group, an n-heptadecyl group, an n-octadecyl group, an n-nonadecyl group, or an n-eicosyl group. The alkyl group of acrylic long chain alkyl ester may be in the form of a straight-chain or branched-chain alkyl group.

One example of the acrylic alkyl ester containing an alkyl group having 1 to 14 carbon atom(s) is commonly known ester used for a conventional (meth)acrylic adhesive. An example of the ester is alkyl ester of an acrylic acid or methacrylic acid whose alkyl group is a methyl group, an ethyl group, a propyl group, a butyl group, a 2-ethylhexyl group, an isooctyl group, isononyl group, isodecyl group, dodecyl group, tridecyl group, lauryl group, or the like.

Chain-structured alkyl (meth)acrylate constituting a main component polymer of the adhesive composition may be used solely or in combination of two or more.

A mixed amount of alkyl (meth)acrylate is not limited as long as a copolymerization reaction with another compound contained in the monomer composition proceeds. The mixed amount may be determined as appropriate depending on intended characteristics of the adhesive composition, such as adhesive strength and heat resistance. On condition that a total amount of a monomer composition including alkyl (meth)acrylate and maleimide-group-containing monomer is 100 parts by mass, it is preferable that the mixed amount of alkyl (meth)acrylate is preferably in a range not less than 10 parts by mass but not more than 90 parts by mass. More preferably, the mixed amount is not less than 20 parts by mass but not more than 70 parts by mass. In a case where the mixed amount is not less than 10 parts by mass, an obtained adhesive layer can be further improved in flexibility and resistance to cracking. In a case where the mixed amount is not more than 90 parts by mass, decrease in heat resistance, peeling failure, and moisture absorption can be prevented.

Moreover, a content of a repeat unit of alkyl (meth)acrylate in a polymer produced by copolymerization of the monomer composition is preferably in a range of 1 mol % to 90 mol %.

(Styrene)

A monomer composition of an adhesive composition of the present invention may further include styrene. Because styrene does not alter in properties even in a high temperature environment at 200° C. or higher, heat resistance of the adhesive composition is improved.

In a case where the monomer composition includes styrene, a mixed amount of styrene is not limited as long as a copolymerization reaction with another compound contained in the monomer composition proceeds. The mixed amount may be determined as appropriate depending on intended characteristics of an adhesive composition, such as adhesive strength and heat resistance. On condition that a total amount of a monomer composition including styrene, alkyl (meth)acrylate, and a maleimide-group-containing monomer is 100 parts by mass, the mixed amount of styrene is preferably in a range not less than 1 part by mass but not more than 60 parts by mass. More preferably, the mixed amount is in a range not less than 20 parts by mass but not more than 55 parts by mass. Most preferably, the mixed amount is in a range not less than 25 parts by mass but not more than 55 parts by mass. In a case where the mixed amount is not less than 1 part by mass, heat resistance can be improved further. In a case where the mixed amount is not less than 60 parts by mass, decrease in resistance to cracking can be prevented.

In a case where a polymer contains styrene, it is preferable that a content of a repeat unit of styrene in the polymer produced by copolymerization of the monomer composition is in a range of 1 mol % to 50 mol %.

(Components Other Than Main Component in Adhesive Composition)

It is possible to further add, to an adhesive composition of the present embodiment, a miscible additive in a range in which essential characteristics of the adhesive composition of the present invention are not impaired. Examples of the additive are commonly used additives such as additive resin for improving adhesiveness, a plasticizer, an adhesive auxiliary agent, a stabilizer, a coloring agent, and a surfactant.

Moreover, an adhesive composition of the present invention may be diluted with an organic solvent for viscosity control in a range in which essential characteristics of the adhesive composition of the present invention is not impaired. Examples of the organic solvent are: ketones such as acetone, methyl ethyl ketone, cyclohexanone, methyl isoamyl ketone, and 2-heptanone; polyols and derivatives thereof such as ethylene glycol, ethylene glycol monoacetate, diethylene glycol, diethylene glycol monoacetate, propylene glycol, propylene glycol monoacetate, monomethyl ether of dipropylene glycol or dipropylene glycol monoacetate, monomethyl ether, monopropyl ether, monobutyl ether, or monophenyl ether; cyclic ethers such as dioxane; or esters such as methyl lactate, ethyl lactate, methyl acetate, ethyl acetate, butyl acetate, methyl pyruvate, ethyl pyruvate, methyl methoxypropionate, and ethyl ethoxypropionate. These organic solvents may be used solely, or in combination of two or more solvents. Particularly, it is preferable to use polyols and derivatives thereof such as ethylene glycol, ethylene glycol monoacetate, diethylene glycol, diethylene glycol monoacetate, propylene glycol, propylene glycol monoacetate, monomethyl ether of dipropylene glycol or dipropylene glycol monoacetate, monomethyl ether, monopropyl ether, monobutyl ether, or monophenyl ether.

An amount of the organic solvent to be used may be set as appropriate depending on a film thickness of the adhesive composition applied. As long as the adhesive composition has a sufficient concentration for being applied to a supporting body such as a semiconductor wafer, the amount is not specifically limited. Generally, the organic solvent is used so that a solid content concentration of an adhesive composition is in a range of 20 mass % to 70 mass %, and, preferably, in a range of 25 mass % to 60 mass %.

[Copolymerization Reaction]

A copolymerization reaction of the monomer composition may be carried out according to a commonly known method, and is not specifically limited. For instance, an adhesive composition of the present invention can be obtained by agitating a monomer composition with a conventional agitator.

A temperature condition of the copolymerization reaction may be set as appropriate and is not limited. It is preferable that the temperature is in a range of 60° C. to 150° C. It is more preferable that the temperature is in a range of 70° C. to 120° C.

Moreover, in the copolymerization reaction, a solvent may be used as appropriate. As the solvent, the organic solvent cited above may be used. Particularly, propylene glycol monomethyl ether acetate, (hereinafter, referred to as “PGMEA”) is preferable as the solvent.

Further, in the copolymerization reaction of the present embodiment, a polymerization initiator may be used as appropriate. Examples of the polymerization initiator are azo compounds such as 2,2′-azobisisobutyronitrile, 2,2′-azobis(2-methylbutyronitrile), 2,2′-dimethyl azobisisobutyrate, 1,1′-azobis (cyclohexane-1-carbonitril), and 4,4′-azobis(4-cyanovaleric acid); and organic peroxides such as decanoyl peroxide, lauroyl peroxide, benzoyl peroxide, bis(3,5,5-trimethylhexanoyl)peroxide, succinic acid peroxide, tert-butylperoxy-2-ethylhexanoete, tert-butyl peroxypivalate, and 1,1,3,3-tetramethylbutylperoxy-2-ethylhexanoate. These polymerization initiators may be used solely, or in combination of two or more initiators as appropriate. An amount of the polymerization initiator to be used may be set as appropriate depending on, for example, a combination of monomer compositions and reaction conditions, and is not specifically limited.

A range of a weight-average molecular weight of a polymer used, in the present invention is preferably 10000 to 300000, more preferably 20000 to 200000, and the most preferably 30000 to 150000. A weight-average molecular weight not less than 10000 provides preferable flexibility. A weight-average molecular weight not more than 300000 provides preferable heat resistance.

[Adhesive Film]

An adhesive composition of the present invention may be used in various ways depending on purposes. For instance, the adhesive composition in a liquid state may be used in a method in which the adhesive composition is applied on a body to be processed, for example, a semiconductor wafer so that an adhesive film is formed. Alternatively, the adhesive composition may be used in the form of an adhesive film of the present invention, that is, in a method (adhesive film method) in which, after an adhesive layer including any one of the adhesive compositions above is formed on a base film such as a flexible film and dried, the film (adhesive film) is attached to a body to be processed.

As described above, an adhesive film of the present invention includes an adhesive layer containing any one of the adhesive compositions above on a base film.

Therefore, in a case where a monomer composition further includes a maleimide-group-containing monomer, heat resistance of the adhesive composition constituting an adhesive layer is improved. This makes it possible to obtain an adhesive film excellent in heat resistance and adhesive strength in a high temperature environment.

In the adhesive film, the adhesive layer may be further covered with a protective film. In this case, after the protective film is peeled from the adhesive layer, the adhesive layer thus exposed is attached to a body to be processed. Then, the base film is peeled. This allows the adhesive layer to be easily provided on the body to be processed.

Therefore, by using the adhesive film, it is possible to form an adhesive layer whose layer thickness is improved in uniformity and whose surface is improved in smoothness, as compared with those of a case where an adhesive layer is directly formed on a body to be processed by application of the adhesive composition.

The base film used for producing an adhesive film is not limited as long as an adhesive layer formed on the base film can be detached from the base film and the base film is a release film which can transfer the adhesive layer onto a surface to be processed of, for example, a protective substrate or a wafer. An example of the base film is a flexible film made of a synthetic resin that has a film thickness of 15 μm to 125 μm and is made of, for example, polyethylene terephthalate, polyethylene, polypropylene, polycarbonate, or polyvinyl chloride. It is preferable that the base film is subjected to a release treatment, if necessary, so that the transfer is performed easily.

A method for forming the adhesive layer on the base film is not limited, and a commonly known method may be used as appropriate depending on a desired thickness and uniformity of the adhesive layer. An example of the method is a method in which the adhesive composition of the present invention is applied on the base film so that a film thickness of a dried adhesive layer is in a range of 10 μm to 1000 μm by using, for example, an applicator, a bar coater, a wire bar coater, a roll coater, and a curtain flow coater. Particularly the roll coater is preferable because the roll coater is capable of efficiently forming a thick layer having an excellent uniformity in thickness.

Moreover, in a case where a protective film is used, the protective film is not specifically limited as long as the protective film can be peeled from an adhesive layer. Preferable examples of the protective film are a polyethylene terephthalate film, a polypropylene film, and a polyethylene film. Further, it is preferable that the protective film is silicone-coated or silicone-baked so that the peeling from adhesive layer becomes easy. Thickness of the protective film is not specifically limited. However, it is preferable that the thickness of the protective film is in a range of 15 μm to 125 μm so that flexibility of the adhesive film including the protective film is ensured.

Usage of the adhesive film is not specifically limited. For instance, in a case where a protective film is used, the adhesive film may be used in a method in which, after the protective film is detached and then an exposed adhesive layer is overlapped on a body to be processed, the adhesive layer is subjected to thermocompression onto a front surface of the body to be processed by running a heating roller on the base film (on a back surface of the surface on which the adhesive layer is formed). In this case, the protective film peeled from the adhesive film can be stored and reused if the protective film is sequentially wound up with the use of a roller such as a reel roller.

Usage of the adhesive composition of the present embodiment is not specifically limited as long as the adhesive composition is used for adhering purposes. The adhesive composition is suitably used as an adhesive composition for attaching, to a substrate such as a semiconductor wafer, a protective substrate for use in processing a semiconductor wafer with high precision. In particular, the adhesive composition of the present invention is suitably used as an adhesive composition for attaching a substrate such as a semiconductor wafer to a support plate, when the substrate is grinded to thin down (e.g., Japanese Unexamined Patent Publication No. 191550/2005, (Tokukai 2005-191550)).

[Peeling Solution]

As a peeling solution for removing the adhesive composition of the present embodiment, a commonly used peeling solution may be used. Particularly, a peeling solution containing PGMEA, ethyl acetate, or methyl ethyl ketone as a main component is preferable in view of reduction in a negative environmental impact and peelability (detachability).

Examples of the adhesive composition of the present invention are provided below. The following examples are merely for properly explaining the present invention, and by no means limit the present invention.

### EXAMPLES

First explained is a specific method for preparing an adhesive composition of Example 1.

111.6 g of PGMEA as a solvent and 30 g of methyl methacrylate, 52 g of styrene, and 18 g of cyclohexylmaleimide as monomers as shown in Table 1, were put into a 300 ml four-neck flask provided with a reflux condenser, a stirrer, a thermometer, and a nitrogen inlet tube. Then, the supply of N₂ was started. Then, agitation was started so as to start polymerization. After a temperature was raised to 100° C. concurrently with the agitation, then, a mixed solution including 13.33 g of PGMEA and 1 g of t-butylperoxy-2-ethylhexanoate (polymerization initiator) was dropped continuously for four hours from a dropping nozzle. The dropping rate was kept constant.

The polymerized solution obtained after the drop was subjected to aging at 100° C. for an hour. Then, the mixed solution including 25.10 g of PGMEA and 0.3 g of t-butylperoxy-2-ethylhexanoate was dropped into the polymerized solution for one hour. Then, the polymerized solution obtained after the drop was subjected to aging at 100° C. for one hour. Then, 1.0 g of 1,1,3,3-tetramethyl butyl peroxy-2-ethylhexanoate was put in at one time. Next, the polymerized solution was subjected to aging at 100° C. for three hours. Then, a temperature of the polymerized solution was raised until solvent reflux appeared. Subsequently, the polymerized solution was subjected to one-hour aging and the polymerization was completed. As a result, Resin 1 was synthesized.

Each of Resins 2, 3 and 5 in Examples 2, 3, and 4, and Resin 4 in Comparative Example 1 was synthesized in the same method as the method of synthesizing Resin 1 in Example 1.

Table 1 shows compositions of monomer compositions in the examples and the comparative example, and an average molecular weight of each of the adhesive compositions obtained by polymerization of the monomer compositions.

TABLE 1

| | | | | | Com- |
|---|---|---|---|---|---|
| | | | | | parative |
| Composition | Example 1 | Example 2 | Example 3 | Example 4 | Example 1 |
| (mass ratio) | (Resin 1) | (Resin 2) | (Resin 3) | (Resin 5) | (Resin 4) |
| Methyl | 30 | 55 | 89 | 20 | 27 |
| methacrylate | | | | | |
| Styrene | 52 | 34 | 0 | 52 | 32 |
| Phenoxy- | 0 | 0 | 0 | 0 | 3 |
| ethyl | | | | | |
| acrylate | | | | | |
| Isobornyl | 0 | 0 | 0 | 0 | 18 |
| methacrylate | | | | | |
| Styrene | 0 | 0 | 0 | 0 | 20 |
| block | | | | | |
| Acrylate | 0 | 0 | 0 | 0 | 5 |
| (random) | | | | | |
| Cyclohexyl- | 18 | 11 | 11 | 28 | 0 |
| maleimide | | | | | |
| Average | 82000 | 80000 | 86000 | 80000 | 97000 |
| molecular | | | | | |
| weight | | | | | |

Each of Resins 1 to 5 were dissolved in propylene glycol monomethyl ether acetate so as to prepare an adhesive composition whose concentration of acrylic polymer was 40 mass %.

The following explains a result of measurement using each of the adhesive compositions obtained in Examples 1 to 4 and Comparative Example 1. In the measurement, for example, adhesive strength was measured.

(Methods for Measuring Heat Resistance, Hygroscopicity, and Degassing Amount)

The adhesive compositions of Examples 1 to 4 and Comparative Example 1 were applied on 6-inch silicon wafers, respectively. Then, the adhesive compositions were dried at 110° C., 150° C., and 200° C. for three minutes each (for nine minutes in total) so as to form a coating film whose thickness is 15 μm. Next, the temperature of each of the coating films was raised from 40° C. to 250° C., and then a degassing amount (an amount of gas generated) from each of the coating films was measured. Heat resistance and hygroscopicity of each adhesive composition were evaluated based on the degassing amount.

The heat resistance and hygroscopicity can be evaluated based on the degassing amount for the reason set forth below. That is, the degassing amount measured at a temperature below 100° C. is derived from water vapor or an azeotropic gas. Further, the water vapor or the azeotropic gas is derived from moisture that is absorbed by the adhesive composition. Therefore, hygroscopicity of the adhesive composition can be evaluated based on the degassing amount at a temperature below 100° C. A degassing amount measured at a temperature above 100° C. is derived from gas that is generated by decomposition of the adhesive composition itself by heat. Therefore, heat resistance of the adhesive composition can be evaluated based on the degassing amount measured at a temperature above 100° C., particularly around 200° C.

In the measurement of the degassing amount, a TDS scheme (Thermal Desorption Spectroscopy scheme) was used. As a Thermal Desorption Spectrometer (emitted gas measuring device), EMD-WA1000 (manufactured by ESCO Ltd.) was used.

Measurement conditions of the Thermal Desorption Spectrometer were as follows: Width: 100, Center Mass Number: 50, Gain: 9, Scan Speed: 4, and Emult Volt: 1.3 kV.

The heat resistance was evaluated at a temperature of 200° C. according to the following definitions: “Good” in a case where an intensity obtained by the Thermal Desorption Spectrometer was less than 100000 and no residue was observed by a metallographic microscope; “Fair” in a case where the intensity was 100000 or more and no residue was observed by a metallographic microscope; “Poor” in a case where the intensity was 100000 or more and residue was observed by a metallographic microscope.

The hygroscopicity was evaluated at a temperature of 100° C. according to the following definitions: “Good” in a case where the intensity was less than 10000; and “Poor” in a case where the intensity was 10000 or more.

Moreover, the degassing amount was evaluated at a temperature of 200° C. according to the following definitions: “Good” in a case where the intensity obtained by Thermal Desorption Spectrometer was less than 100000; and “Poor” in a case where the intensity was 100000 or more.

(Evaluation of Flexibility)

Each of the adhesive compositions was applied on a 6-inch silicon wafer by a spinner at 1000 rpm for 25 seconds. Then, a coating layer was formed on the silicon wafer by heating at 200° C. for three minutes on a hot plate. Next, presence or absence of a crack on the coating layer was visually checked and evaluated as follows: “Poor” in a case where any crack appeared; and “Good” in a case where no crack appear. Here, the thickness of the coating layer in the observation was 15 μm.

(Adhesive Strength at Various Temperatures)

The adhesive compositions of Examples 1 to 4 and Comparative Example 1 were applied on silicon wafers, respectively. Then, each of the adhesive compositions was dried for three minutes. Next, a glass substrate was attached to each of the obtained silicon wafers with a load of 1 kg at 200° C. Then, the glass substrate was pulled, and adhesive strength at the time when the glass substrate is peeled from each of the silicon wafers was calculated by using a vertical electric measurement stand MX-500N (manufactured by IMADA CO., LTD). The adhesive strength was evaluated as follows: “Good” in a case where the adhesive strength was 2 kg/cm² or more; and “Poor” in a case where the adhesive strength was less than 2 kg/cm².

Regarding the adhesive compositions of Examples 1 to 4 and Comparative Example 1, adhesive strength, degassing, heat resistance, flexibility, and hygroscopicity at a temperature of 250° C. were compared with one another. The result of the comparison is shown in Table 2.

TABLE 2

| Evaluation | Exam- | Exam- | | | Comparative |
|---|---|---|---|---|---|
| results | ple 1 | ple 2 | Example 3 | Example 4 | Example 1 |
| Adhesive | Good | Good | Good | Good | Poor |
| strength at high | | | | | |
| temp. (250° C.) | | | | | |
| Degassing | Good | Good | Good | Good | Good |
| Heat resistance | Good | Good | Good | Good | Good |
| Flexibility | Good | Good | Good | Good | Good |
| Hygroscopicity | Good | Good | Good | Good | Good |

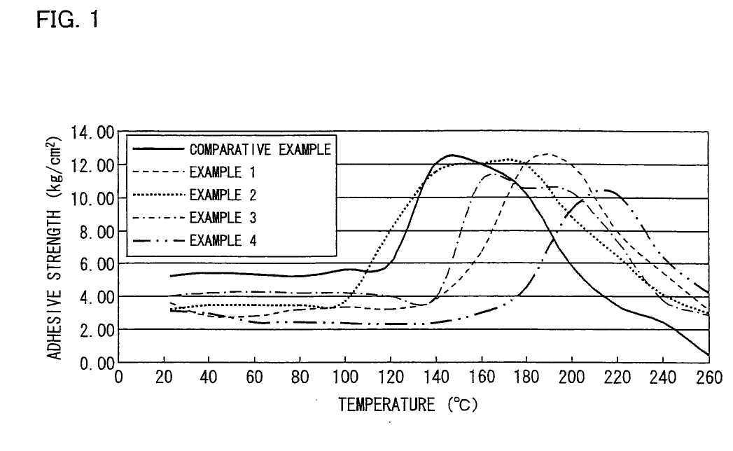

Regarding the adhesive compositions of Examples 1 to 4 and Comparative Example 1, adhesive strengths at 13 points in a temperature range 23° C. to 260° C. were compared with one another. The result of the comparison is shown in Table 3 and FIG. 1.

In FIG. 1, the horizontal axis represents temperature, and the vertical axis represents adhesive strength (kg/cm²).

TABLE 3

| Adhesive | | | | | |
|---|---|---|---|---|---|
| Strength at | | | | | |
| Various | | | | | Com- |
| Temperatures | Exam- | | | | parative |
| (kg/cm²) | ple 1 | Example 2 | Example 3 | Example 4 | Example 1 |
| 23° C. | 3.59 | 3.20 | 4.00 | 3.12 | 5.22 |
| 40° C. | 2.82 | 3.50 | 4.20 | 2.99 | 5.40 |
| 60° C. | 2.82 | 3.50 | 4.30 | 2.45 | 5.38 |
| 80° C. | 3.21 | 3.50 | 4.20 | 2.45 | 5.20 |
| 100° C. | 3.33 | 3.70 | 4.19 | 2.38 | 5.60 |
| 120° C. | 3.21 | 8.00 | 4.00 | 2.33 | 6.00 |
| 140° C. | 3.80 | 11.49 | 3.94 | 2.41 | 12.00 |
| 160° C. | 6.70 | 12.00 | 11.00 | 3.02 | 12.00 |
| 180° C. | 12.00 | 12.00 | 10.52 | 4.46 | 10.26 |
| 200° C. | 12.00 | 8.83 | 10.32 | 9.17 | 5.90 |
| 220° C. | 8.00 | 6.50 | 7.39 | 10.22 | 3.50 |
| 240° C. | 5.50 | 4.14 | 3.81 | 6.46 | 2.50 |
| 260° C. | 3.21 | 3.00 | 2.90 | 4.32 | 0.50 |

As shown in Table 3 and FIG. 1, the adhesive composition of the present invention was found to have high adhesive strength at a temperature above 250° C. On the other hand, the adhesive composition of Comparative Example 1 could not keep sufficient adhesive strength at a temperature above 250° C. Note that an adhesive strength of 2 kg/cm² or more is strong enough for practical use.

An adhesive composition of the present invention, as described above, includes: a polymer as a main component, the polymer being obtained by copolymerization of a monomer composition containing meleimide-group-containing monomer and chain-structured alkyl (meth)acrylate. Therefore, an obtained adhesive composition includes: an imide ring in a main chain of the polymer, which imide ring being derived from a maleimide-group-containing monomer. This leads to improvement in heat resistance at a high temperature, adhesiveness in a high temperature environment, and alkali resistance of the obtained adhesive composition.

Therefore, the present invention can provide an adhesive composition that has high heat resistance, high adhesive strength in a high temperature environment (particularly at 200° C. to 250° C.), and high alkali resistance and that can be peeled off easily after a high temperature process such as a heating process of heating at 250° C. for one hour.

An adhesive composition and an adhesive film of the present invention have high heat resistance, low hygroscopicity, a small degassing amount at the time of heating, and excellent adhesive strength at a high temperature. Therefore, the adhesive composition and adhesive film of the present invention are suitable for use in processing a semiconductor wafer or a chip produced through a high temperature process.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1-7. (canceled)

8. An adhesive composition comprising:
a polymer as a main component and an organic solvent,
the polymer being produced by copolymerization of a monomer composition containing chain-structured alkyl (meth)acrylate,
the monomer composition further containing a monomer containing a maleimide group.

9. The adhesive composition as set forth in claim 8, wherein the monomer composition is 100 parts by mass and an amount of the monomer containing a maleimide group is in a range not less than 1 part by mass but not more than 50 parts by mass.

10. The adhesive composition as set forth in claim 8, wherein:
the monomer containing a maleimide group is a monomer represented by: 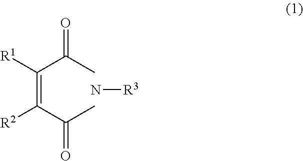
where each of R1 to R3 independently represents a hydrogen atom or an organic group having 1 to 20 carbon atom(s).

11. The adhesive composition as set forth in claim 8, wherein:
the monomer containing a maleimide group is N-methylmaleimide, N-cyclohexylmaleimide, or N-phenylmaleimide.

12. The adhesive composition as set forth in claim 8, wherein:
a content of a repeat unit containing a maleimide-group in the polymer is in a range of 1 mol % to 20 mol %.

13. The adhesive composition as set forth in claim 8, wherein:
the monomer composition further contains styrene.

14. An adhesive film comprising:
an adhesive layer containing the adhesive composition as set forth in claim 8.

15. The adhesive composition as set forth in claim 10, wherein the organic group contains an atom selected from the group consisting of oxygen atom, a nitrogen atom, a sulfur atom, and a halogen atom.

16. An adhesive composition comprising an organic solvent and a polymer as a main solids component, the polymer being produced by copolymerization of monomer composition containing chain-structured alkyl (meth)acrylate and a monomer containing a maleimide group.
